(19) United States
(12) Patent Application Publication
(10) Pub. No.: US 2008/0005689 A1
(43) Pub. Date: Jan. 3, 2008

(54) Apparatus and method for defining file object attribute perspectives

(75) Inventors: Dale Raymond Evernden, Vancouver (CA); Graeme Andrew Kyle Roche, Brentwood Bay (CA)

Correspondence Address: COOLEY GODWARD KRONISH LLP;ATTN: Patent Group, Suite 1100, 777 - 6th Street, NW, Washington, DC, 20001, US

(73) Assignee: Business Objects, S.A., Levallois-Perret (FR)

(21) Appl. No.: 11/478,841

(22) Filed: Jun. 30, 2006

(51) Int. Cl. G06F 3/048

(52) U.S. Cl. 715/765; 715/764

(57) ABSTRACT

A computer readable medium stores executable instructions to graphically display file object attributes of one or more file objects. Executable instructions receive from a list of file object attribute perspectives a selection of a selected file object attribute perspective specifying one or more file object attribute categories. Executable instructions also display the file object attribute categories for the selected file object attribute perspective and the corresponding file object attributes for each file object.

### BRIEF DESCRIPTION OF THE INVENTION

This invention relates generally to digital data processing. More particularly, this invention relates to ascribing attribute perspectives to file objects.

### BACKGROUND OF THE INVENTION

Methods for displaying attributes of file objects in the prior art include file management programs which typically display one or more file object attribute categories and associated file object attributes in a window of a graphical user interface (GUI). Such file management programs typically allow a user to select a data source comprising particular file objects they wish to have displayed, and may allow a user to manipulate file objects within the GUI to facilitate such common actions as moving or copying file objects. Some file management programs may also allow a user to individually turn on or turn off a file object attribute category in the GUI window, to selectably display or not display an individual file object attribute category, and corresponding file object attributes in the GUI window.

It would be desirable to provide improved techniques for displaying file object attributes in a window of a GUI. More particularly, it would be desirable to provide improved techniques and systems for displaying file object attributes in a window of a GUI to provide a user with contextual information or insight into at least one aspect of the file objects.

### SUMMARY OF INVENTION

The invention includes a computer readable medium to store executable instructions to graphically display file object attributes of one or more file objects. Executable instructions receive from a list of file object attribute perspectives a selection of a selected file object attribute perspective specifying one or more file object attribute categories. Executable instructions also display the file object attribute categories for the selected file object attribute perspective and the corresponding file object attributes for each file object.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates a series of processing operations associated with an embodiment of the invention.

FIG. 2A illustrates a series of processing operations associated with a user-oriented embodiment of the invention.

FIG. 3 illustrates a graphical user interface (GUI) configured in accordance with an embodiment of the invention.

FIG. 4 illustrates a workflow associated with the graphical user interface (GUI) of the embodiment illustrated in FIG. 3.

FIG. 5 illustrates a graphical user interface (GUI) configured in accordance with an embodiment of the invention.

FIG. 6 illustrates a graphical user interface (GUI) configured in accordance with an embodiment of the invention.

FIG. 7 a graphical user interface (GUI) configured in accordance with an embodiment of the invention.

Like reference numerals refer to corresponding parts throughout the several views of the drawings.

### DETAILED DESCRIPTION OF THE INVENTION

The following terminology is used while disclosing embodiments of the present invention:

File Object: a computer file, program, directory folder or other exemplary structure comprising data or metadata. File objects are typically stored in a repository. Further examples of file objects comprise: Microsoft Office™ (from Microsoft Corporation of Redmond, Wash., USA) document files (e.g. .doc, .xls, .ppt, .mdb, .pst, .vsd, etc.), text files (e.g. .txt, .rtf, etc.), spreadsheet files, database files, presentation files, graphics files (e.g. .jpg, .gif, .png, .bmp, .tif, etc.), Macromedia Flash™ (from Adobe Systems, Inc. of San Jose, Calif.) files (e.g. .swf, .fla, etc.), template files, file directory folders, markup language files (.html, .xml, etc.), hyperlinks, programs, executable files, data connections, computer connections (user computers, servers, groups of computer connections such as user groups and server groups, etc.), users, user profiles, calendar and event files, email files, network access levels, network profiles, and business intelligence related file objects (such as related to products from Business Objects S.A., of San Jose, Calif.) comprising reports, templates, schedules, metrics, formulas, rules, actions, alerts, OLAP files, semantic layer objects, dashboard files, universes, universe connections, categories, dimensions, query and analysis files, etc.

File Object Attribute: data characterizing a property of a file object, such as the text specifying a file name, the numbers specifying a file size or the text specifying an author.

File Object Attribute Category: a heading for a particular type of file object attribute, such as “name”, “size”, “date”, “author”, etc. Other examples of file object attribute categories comprise: label, file object type, owner, date and time created and last modified, status, review process, author, author quality, last modified by, languages, last refresh date, security, description, instances, last run, title, schedule status, shared status, access level, machine name, server, server group, protocol, file object security level, net security, net access, first name, last name, account name, etc.

File Object Attribute Perspective: a group of file object attribute categories. A file object attribute perspective may provide a user with contextual information or insight into at least one aspect of one or more file objects.

File Object Manager: a program that displays information about file objects, and allows the manipulation and management of file objects stored in one or more repositories—also known as a file management program.

Data Connector: a program, commonly known as a driver program that provides and controls read/write access to and from a repository to one or more other programs, such as a file object manager.

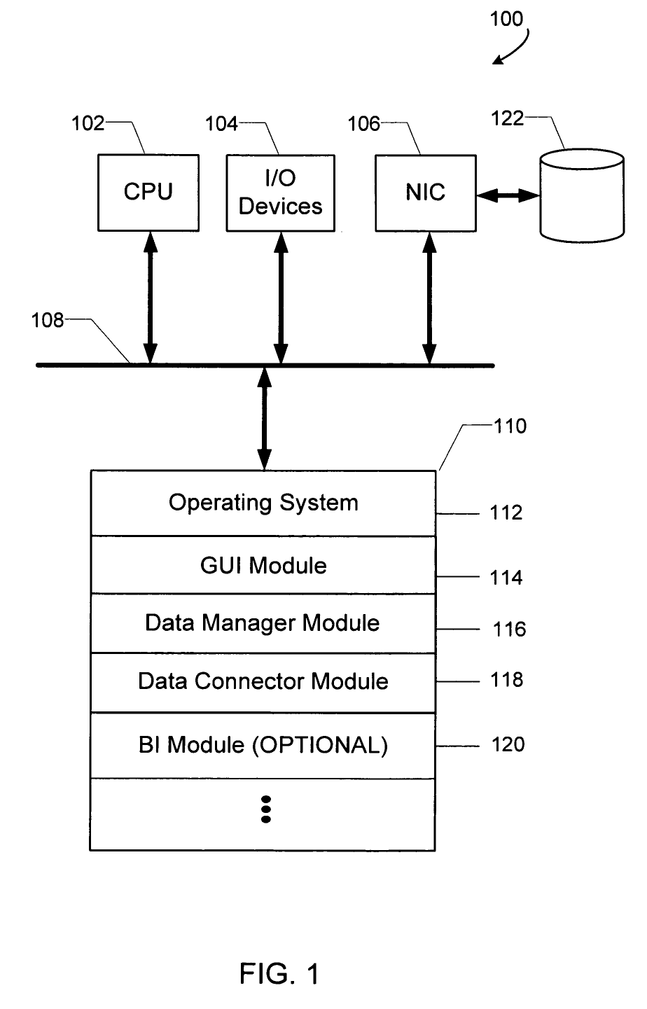

FIG. 1 illustrates a computer 100 configured in accordance with an embodiment of the invention. The computer 100 includes standard components, including a central processing unit 102 and input/output devices 104, which are linked by a bus 108. The input/output devices 104 may include a keyboard, mouse, touch screen, monitor, printer, and the like. A network interface circuit (NIC) 106 is also connected to the bus 108. The network interface circuit 106 provides connectivity to a network (not shown), thereby allowing the computer 100 to operate in a networked environment. One or more data sources, such as repository 122 may also be connected to the computer 100 through the NIC 106. Alternatively, repository 122 may be connected directly, or locally, to the computer 100 such as to bus 108, rather than through the NIC 106.

A memory 110 is also connected to computer 100 through the bus 108. The memory 110 stores executable instructions to implement operations of the invention. In one embodiment, the memory 110 stores one or more of the following modules: an operating system module 112, a Graphical User Interface (GUI) module 114, a file object manager module (also called a data manager module) 116, a data connector module 118, and optionally, a Business Intelligence (BI) module 120.

The operating system module 112 may include instructions for handling various system services, such as file services or for performing hardware dependant tasks. The GUI module 114 may rely upon standard techniques to produce graphical components of a user interface, e.g., windows, icons, buttons, menus and the like, examples of which are discussed below. The user interface may include instructions to receive input from a pointer device and display a cursor on an output device.

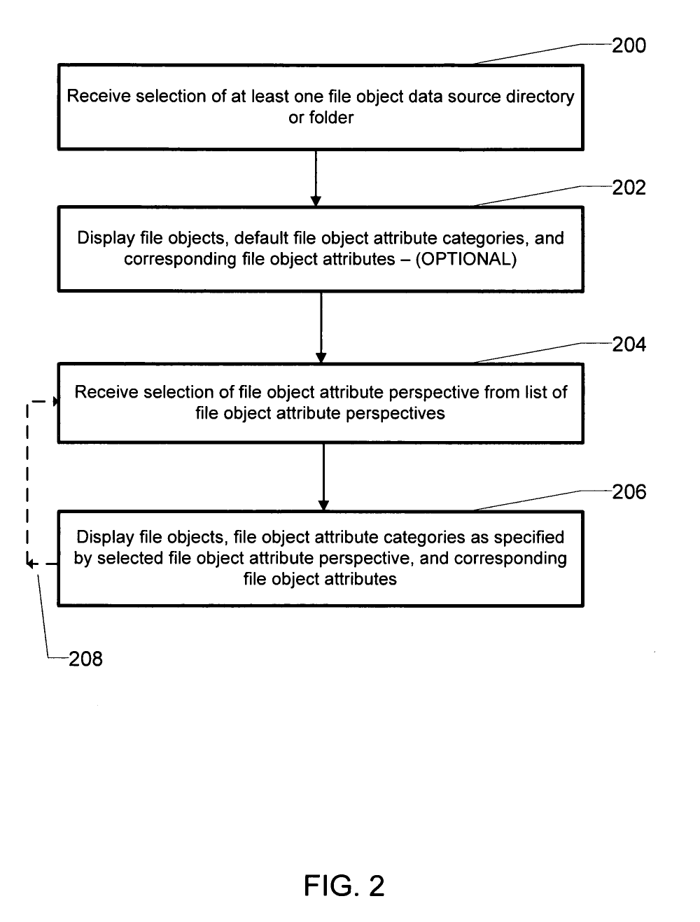

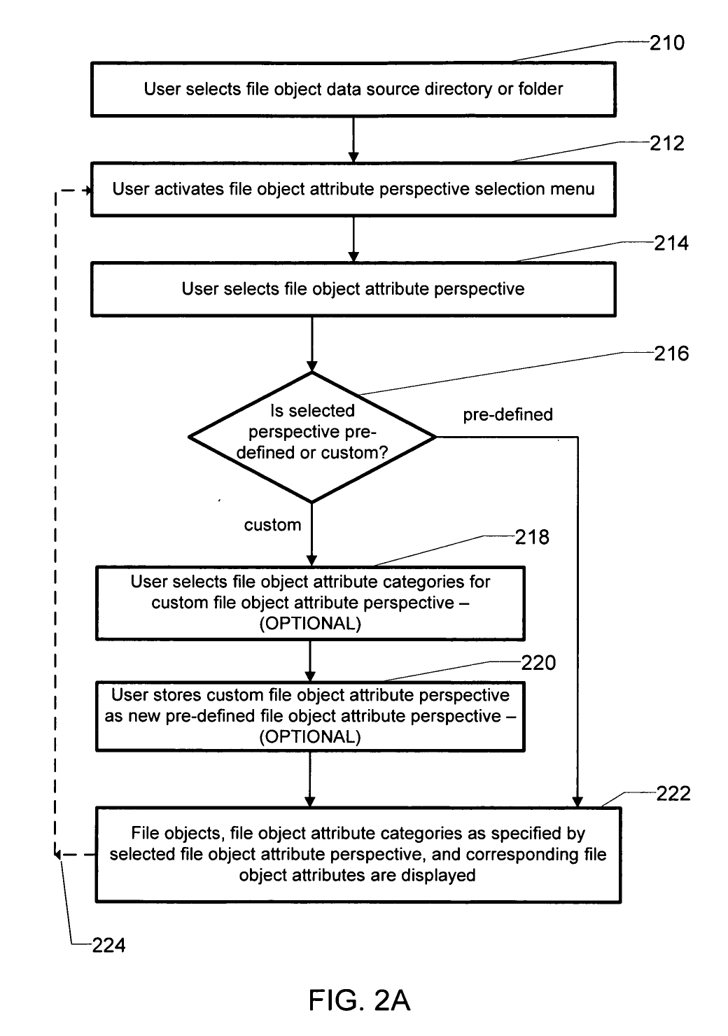

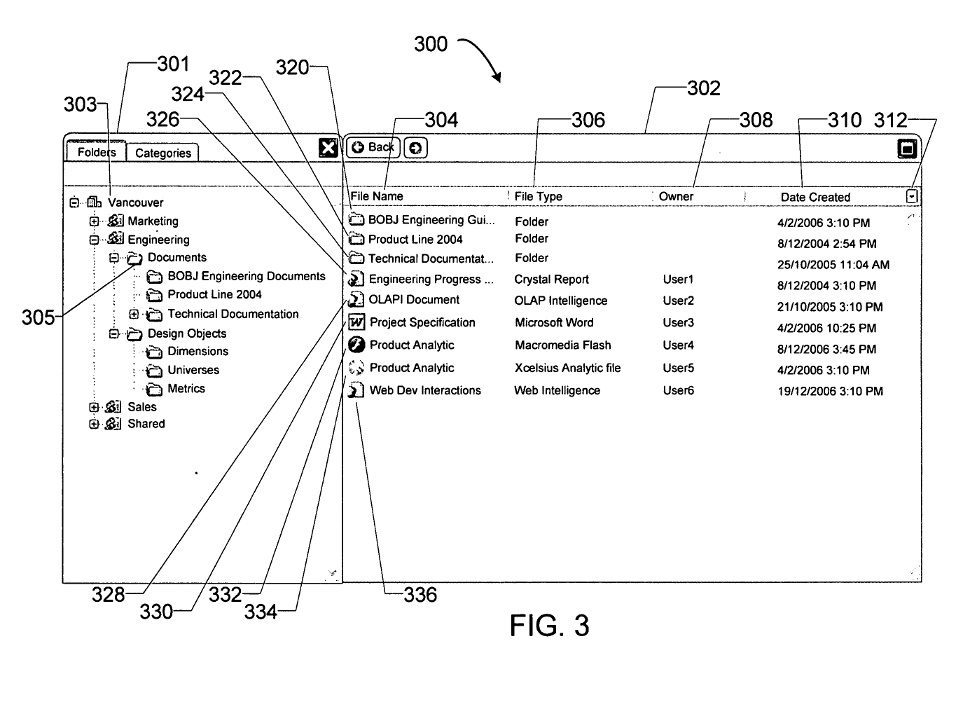

The file object manager module 116 includes instructions for accessing and manipulating file objects, and for displaying information related to the file objects in a graphical format, such as a GUI. In one embodiment, the file object manager module may comprise instructions for accessing and storing file objects, and in conjunction with the GUI module 114, for displaying attributes of the file objects. These attributes may comprise metadata related to the corresponding file objects, or that are calculated or otherwise determined from the corresponding file objects. The file object manager module 116 and GUI module 114 may be used to implement the operations of FIGS. 2-2A and the GUIs of FIGS. 3-7.

The data connector module 118 includes instructions for accessing at least one data source where file objects are stored. In one embodiment the data connector module 118 may comprise instructions for accessing at least one repository 122 connected to the computer 100 either directly (also referred to as a local repository) or through a network, and for retrieving file objects from and writing file objects to the repository 122. In another embodiment, the data connector module 118 may be incorporated into the file object manager module 116, in which case the file object manager module 116 may include instructions for accessing at least one data source, such as repository 122.

The optional BI module 120 may comprise executable instructions to perform Business Intelligence (BI) related functions, such as, generate, view or share reports, perform queries and analyses, and the like.

The executable modules stored in memory 110 are exemplary. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

FIG. 2 illustrates a series of processing operations that may be implemented by the computer 100. The first processing operation of FIG. 2 is to receive a selection of at least one file object data source directory or folder 200. Typically, the at least one selected data source directory or folder comprises at least one file object. In a particular embodiment, the selected data source may comprise a repository. In an optional embodiment of the invention, particular file objects to be displayed in following operation 206 may be selected from within the at least one selected data source directory or folder.

The second processing operation of FIG. 2 is to optionally display file objects, default file object attribute categories, and corresponding file object attributes 202. In one embodiment of the invention which includes processing operation 200, a set of file objects stored in one or more particular directories or folders of a data source may be displayed, as well as one or more default file object attribute categories, and file object attributes for file objects that correspond to the default file object attribute categories. File objects, default file object attribute categories and corresponding file object attributes may be displayed in conjunction with the initial execution of a file object manager program 116, which may be used to implement processing operation 202.

The third processing operation of FIG. 2 is to receive a selection of a file object attribute perspective from a list of file object attribute perspectives 204. The list of file object attribute perspectives may comprise two or more perspectives. Each file object attribute perspective preferably includes a group of file object attribute categories which are related to convey contextual information or insight into at least one aspect of one or more file objects to a user, when the file object attributes corresponding to the file object attribute categories in a perspective are displayed together.

The next processing operation of FIG. 2 is to display file objects, file object attribute categories as specified by the selected file object attribute perspective, and corresponding file object attributes 206.

In an optional embodiment of the present invention, following completion of processing operation 206, the series of operations illustrated in FIG. 2 may return to processing operation 204 to receive a further selection of a file object attribute perspective, via optional processing loop 208. Alternatively, the series of processing operations illustrated in FIG. 2 may end with operation 206.

FIG. 2A illustrates a series of user workflow operations according to an aspect of the invention. In the first operation of FIG. 2A the user selects at least one file object data source directory or folder 210. The file object data source directory or folder may be selected from any available data source to which the user has access, which may include local and network data sources. Preferably, the at least one selected data source directory or folder comprises at least one file object. In a particular embodiment, the selected data source may comprise a repository. In an optional embodiment of the invention, particular file objects to be displayed in subsequent operation 222 may be selected from within the at least one selected data source directory or folder.

In the second operation of FIG. 2A, the user activates a file object attribute perspective selection menu 212. For example, the user may activate the file object attribute perspective selection menu with a keyboard input or by clicking on an item in a GUI, such as a button or icon. In an alternate embodiment, the file object attribute perspective selection menu may comprise a list or other means for displaying file object attribute perspectives for selection, and may be activated by user selection of an item in a GUI, or by alternate means such as a keyboard input or combination of inputs, such as a function key or other key combination.

In the third operation of FIG. 2A, the user selects a file object attribute perspective 214. The file object attribute perspective may be selected from the file attribute perspective selection menu activated by the user in the previous operation 212 above, such as by clicking on a pull-down menu item or other representation of the desired file object attribute perspective in a GUI.

Following the selection of a file object attribute perspective in operation 214, it is determined if the selected file object attribute perspective is a pre-defined perspective, or a custom perspective in operation 216. In an embodiment of the invention, one or more pre-defined file object attribute perspectives may appear in the same file object attribute perspective selection menu activated by the user in operation 212. In an optional embodiment, at least one custom file object attribute perspective may also appear in the file object attribute selection menu activated by the user. If the selected file object attribute perspective is a pre-defined perspective, the workflow operations of FIG. 2A may proceed directly to operation 222 described below. Alternatively, in an optional embodiment including a custom file object attribute perspective, if the selected file object attribute perspective is a custom perspective, the workflow operations of FIG. 2A may proceed to optional operations 218 and 220, described below.

In an optional embodiment of the present invention directed towards a custom file object attribute perspective, in operation 218 of FIG. 2A the user selects one or more file object attribute categories for inclusion in the custom file object attribute perspective. The user may select file object attribute categories from a list of available file object attribute categories which may be activated by the selection of a custom perspective in operation 214. In an embodiment of the invention, a list of available file object attribute categories may comprise one or more file object attribute categories available for particular file objects in the selected data source directory or folder, or alternatively may comprise a preset or default set of file object attribute categories.

In one embodiment of the present invention, in optional operation 220 of FIG. 2A the user stores the custom file object attribute perspective as a new pre-defined file object attribute perspective. The new pre-defined file object attribute perspective may be stored locally on a user's computer or data source connected to the user's computer, or alternatively in a repository or other suitable data storage means, and may be stored in a similar location to other pre-defined file object attribute perspectives, or in a particular location designated for storage of custom defined perspectives. Following optional operation 220, the user workflow proceeds to operation 222 described below.

In the next operation of FIG. 2A, file objects, file object attribute categories as specified in the selected file object attribute perspective, and corresponding file object attributes are displayed 222.

In a further optional embodiment of the workflow illustrated in FIG. 2A, following completion of operation 222, the workflow illustrated in FIG. 2A may return to operation 212 via optional workflow loop 224.

FIG. 3 illustrates a graphical user interface (GUI) 300 used to implement an embodiment of the invention. The GUI 300 could be included in a window presented on an output device of computer 100. The GUI 300 may typically comprise at least two panes, including a directory pane 301 and at least one attribute pane 302. The directory pane 301 is used to display a representation of a data source directory containing file objects, exemplified by a standard directory tree structure 303. The data source, such as a repository, may typically be divided into multiple directories or folders. At least one directory or folder 305 containing one or more file objects may be selected in the directory pane, to display file object attributes of the file objects in the attribute pane 302.

Attribute pane 302 displays object attributes of file objects corresponding to one or more file object attribute categories, including a label or index file object attribute category. In GUI 300, “File Name” file object attribute category 304 is used as the label or index file object attribute category, and appears at the top of attribute pane 302 alongside additional exemplary file object attribute categories “File Type” 306, “Owner” 308 and “Date Created” 310. In a preferred embodiment, the label or index file object attribute category is displayed on the left hand side of the attribute panel in order to facilitate identifying the file object by its label or index attribute. In the exemplary GUI 300, the file name file object attribute category 304 is used as a label file object attribute category to identify file objects, and as such is preferably displayed on the left hand side of the attribute pane 302. File object attributes may typically be displayed in rows beneath corresponding file object attribute categories. In GUI 300, the file objects displayed in the attribute pane 302 include three folder file objects 320, 322, and 324, a business intelligence report document, 326, an OLAP document 328, a wordprocessor document 330, a .swf file 332, a business intelligence analytic file 334, and query and analysis file 336. The label attributes of these file objects as displayed in the attribute pane 302 also preferably include an icon related to the type of file object, to aid in recognition of the file objects. File object attributes for each of these file objects (in addition to the label attribute displayed on the left hand side of pane 302) corresponding to the file object attribute categories 306, 308 and 310 are displayed in rows. In the case where the file objects displayed in attribute pane 302 include a directory or folder that may contain other file objects, such as folder file objects 320, 322 and 324, a user may select a folder displayed in the attribute pane 302 to open the folder, and display any file objects contained therein. In such a case, the selected folder 305 displayed in the directory pane 301 may be updated to display the newly selected folder. Attribute pane 302 also includes a file object attribute perspective selection button 312 which if selected, activates a dropdown list of selectable file object attribute perspectives.

In one embodiment of the invention, the particular file object attribute categories 304, 306, 308, and 310 displayed in the attribute pane 302 of GUI 300 may be defined as a “General” file object attribute perspective, which includes the most basic information about the file objects 320, 322, 324, 326, 328, 330, 332, 334, and 336, namely the name, type, owner, and creation date of the file objects. This General file object attribute perspective displays information about file objects that provide a user with contextual information and insight related to the basic properties of the file objects. In a particular embodiment, a default set of file object attribute categories may be defined (the above mentioned “General” file object attribute perspective is an example of a set of file object attribute categories that may be used for a default set) and automatically displayed in the attribute pane 302 of GUI 300 upon the initial execution of a file object manager program incorporating GUI 300 to show information about file objects and to assist a user to decide which file objects they wish to manipulate.

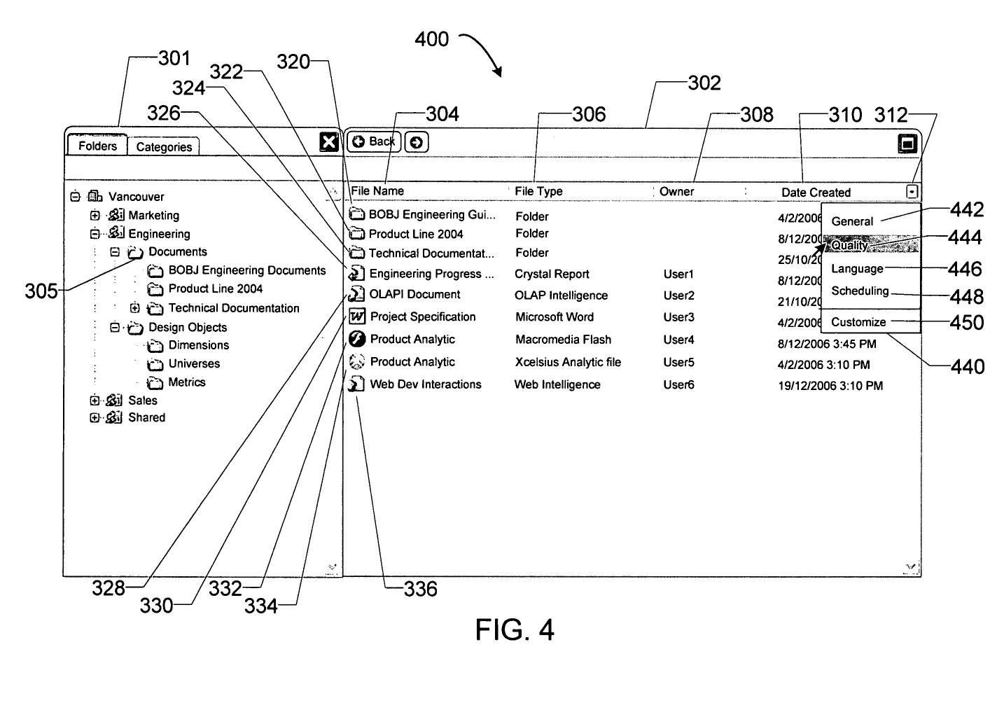

FIG. 4 illustrates a workflow 400 associated with GUI 300, according to an aspect of the invention. In the workflow 400, a file object attribute perspective is selected from a list of file object attribute perspectives. In a user-oriented exemplary embodiment, a user may select file object attribute perspective selection button 312, to activate dropdown file object attribute perspective list 440 which includes pre-defined selectable file object attribute perspectives comprising General 442, Quality 444, Language 446 and Scheduling 448 perspectives. The user may then select a desired file object attribute perspective, as shown for Quality file object attribute perspective 444, which is shown as selected. Following the selection of a desired file object attribute perspective, the file object attribute categories specified in the selected file object attribute perspective, and the file object attributes corresponding to those categories are displayed, as shown in the following figures. In another embodiment of the invention, a file object attribute perspective may additionally specify the order in which the group of file object attribute categories specified by the perspective are to be displayed in the attribute panel 302.

In one optional embodiment of the invention, the dropdown perspective list 440 may also include a custom or “Customize” perspective option 450, which may allow a user to define their own file object attribute perspective, such as by specifying a set of file object attribute categories to display together in the attribute pane 302, to provide contextual information or insight into an aspect of one or more file objects. In a particular embodiment, once a new user-defined or custom file object attribute perspective is defined, it may be stored, and/or added to the dropdown perspective list 440 as a new pre-defined selectable file object attribute perspective.

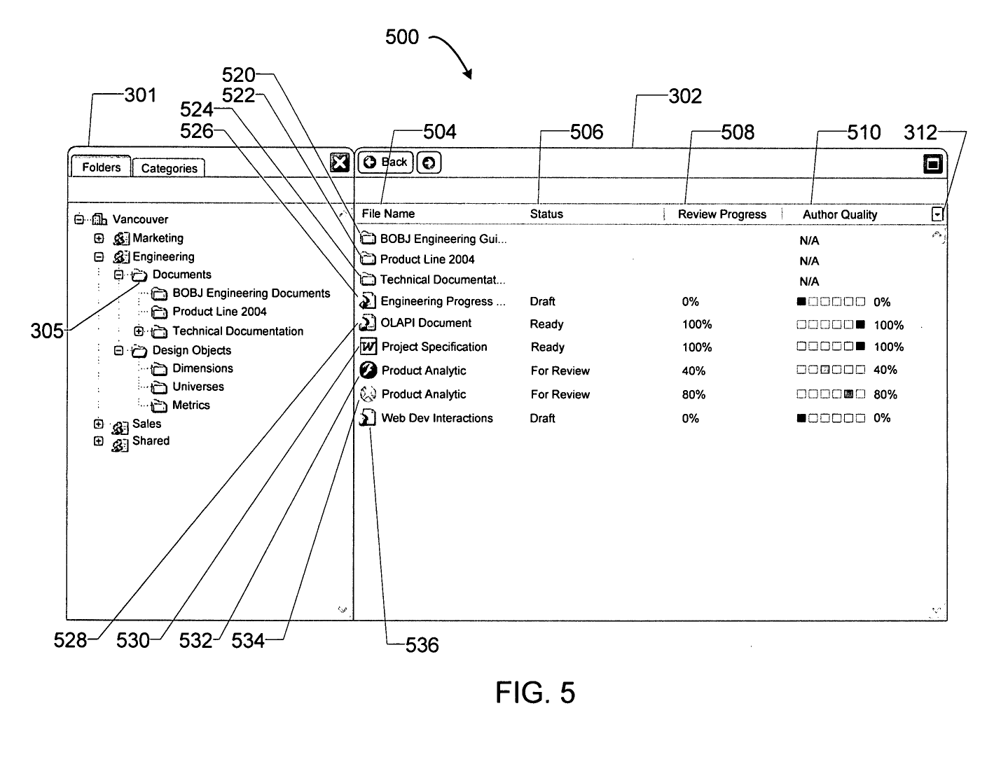

FIG. 5 illustrates a GUI 500 configured in accordance with an aspect of the invention. The GUI 500 could be included in a window presented on an output device of computer 100. The GUI 500 includes directory pane 301 and attribute pane 302, similar to those of FIG. 3. Attribute pane 302 is configured corresponding to the selection of an exemplary Quality file object attribute perspective 444. File Name 504, Status 506, Review Progress 508 and Author Quality 510 file object attribute categories, and corresponding file object attributes for the data objects 520, 522, 524, 526, 528, 530, 532, 534, and 536 are displayed in attribute pane 302, as specified in an exemplary Quality file object attribute perspective 444. The exemplary Quality file object attribute perspective 444 provides a user with contextual information and insight into aspects of displayed file objects related to the quality of the file objects, such as the quality of the author, progression of a review process, and status of the data objects. It should be noted that according to a particular embodiment of the invention, it is not required that every file object displayed in the attribute pane 302 have an attribute value for every file object attribute category included in a file object attribute perspective, as shown for file objects 520, 522 and 524, which do not have attribute values for Status 506 and Review Progress 508 file object attribute categories.

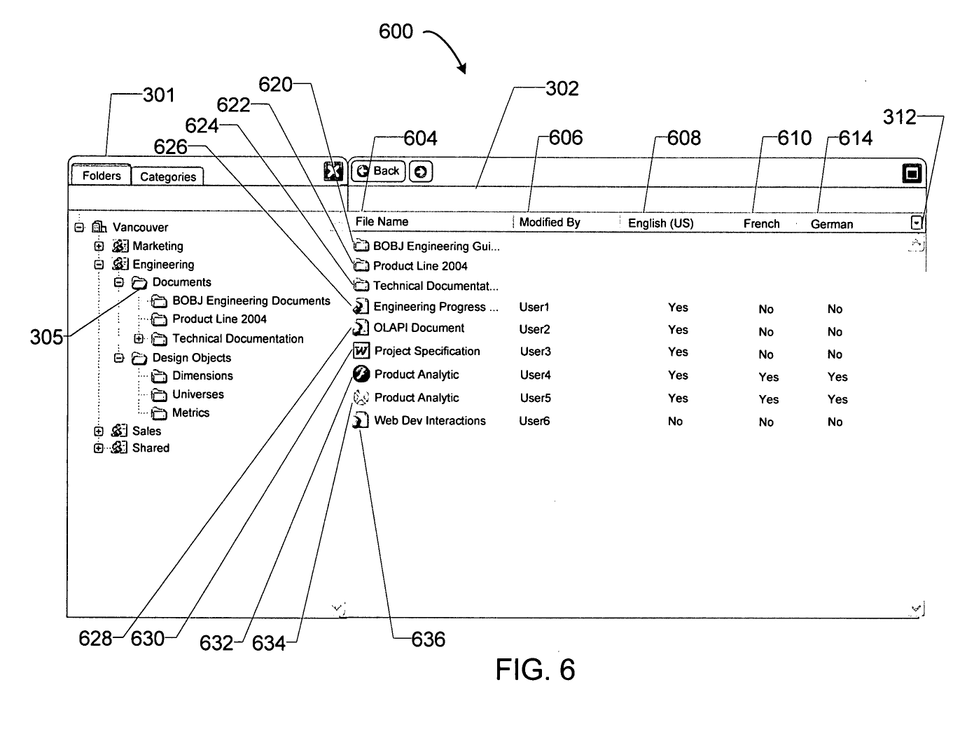

FIG. 6 illustrates a GUI 600 configured in accordance with an aspect of the invention. The GUI 600 could be included in a window presented on an output device of computer 100. The GUI 600 includes directory pane 301 and attribute pane 302. Attribute pane 302 is configured corresponding to the selection of an exemplary Language file object attribute perspective 446. File Name 604, Modified By 606, English (US) 608, French 610 and German 614 file object attribute categories, and corresponding file object attributes for the file objects 620, 622, 624, 626, 628, 630, 632, 634, and 636 are displayed in attribute pane 302, as specified in an exemplary Language file object attribute perspective 446. The exemplary Language file object attribute perspective 446 provides a user with contextual information and insight into aspects of displayed file objects related to the available languages of the file objects, such as the availability of the file objects in the English (US), French and German languages, and the identity of the last user to modify the file objects. As noted above, according to a particular embodiment of the invention, it is not required that every file object displayed in the attribute pane 302 have an attribute value for every file object attribute category included in a file object attribute perspective.

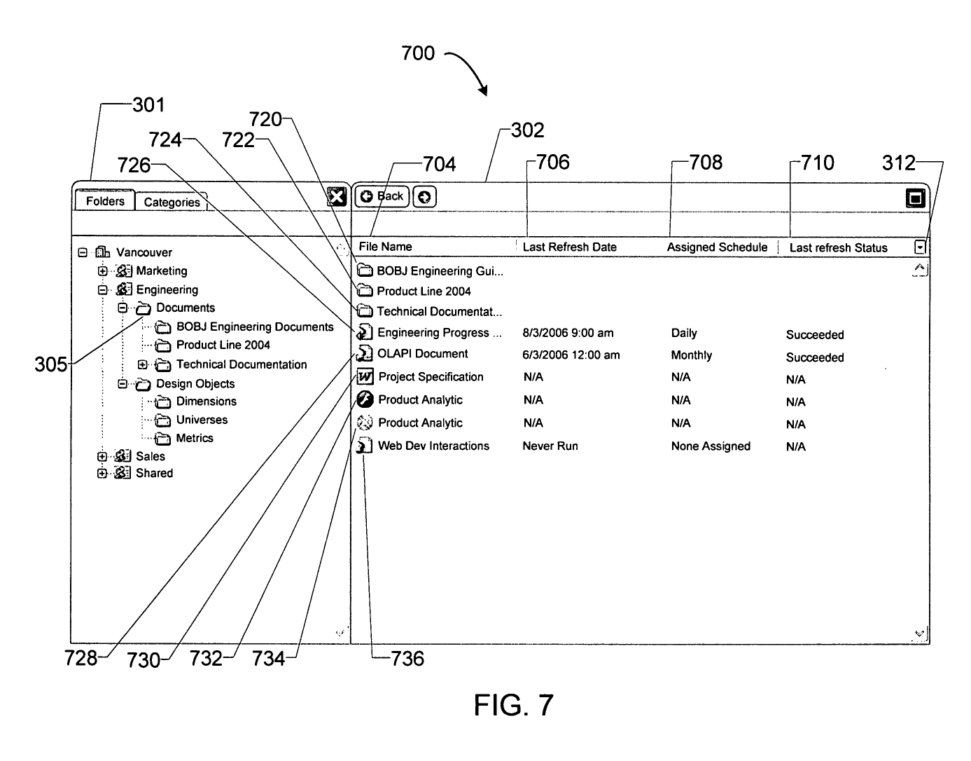

FIG. 7 illustrates a GUI 700 configured in accordance with an aspect of the invention. The GUI 700 could be included in a window presented on an output device of computer 100. The GUI 700 includes directory pane 301 and attribute pane 302. Attribute pane 302 is configured for selection of an exemplary Scheduling file object attribute perspective 448. File Name 704, Last Refresh Date 706, Assigned Schedule 708 and Last Refresh Status 710 file object attribute categories, and corresponding file object attributes for the file objects 720, 722, 724, 726, 728, 730, 732, 734, and 736 are displayed in attribute pane 302, as specified in an exemplary Scheduling file object attribute perspective 448. The exemplary Scheduling file object attribute perspective 448 provides a user with contextual information and insight into aspects of displayed file objects related to refresh scheduling and progress of the file objects, such as the last date the file objects were refreshed, the status of the last refresh, and the refresh schedule assigned to the file objects. As noted above, according to a particular embodiment of the invention, it is not required that every file object displayed in the attribute pane 302 have an attribute value for every file object attribute category included in a file object attribute perspective.

According to an embodiment of the invention, in the case where a selected file object attribute perspective includes more file object attribute categories than can be viewed simultaneously within an attribute pane in a GUI, a scrolling or other suitable known GUI method may be incorporated into the attribute pane of the GUI in order to allow viewing of all of the file object attribute categories, and corresponding file object attributes.

According to another embodiment of the invention, a sort feature may be incorporated into a GUI embodying the invention, such that the order of display of file objects and their file object attributes in an attribute pane may be sorted on the basis of the attribute values corresponding to at least one of the file object attribute categories specified by a file object attribute perspective. Further, the specification for a particular file object attribute perspective may optionally include a default sort instruction, so that upon selecting that perspective, the file objects may be sorted in a predetermined default manner.

According to a further embodiment of the invention, a filter functionality comprising a filter condition may be optionally incorporated into the specification of a given file object attribute perspective, so that upon selection of the file object attribute perspective, file objects that do not meet the requirements of the filter condition are not displayed in the attribute pane. In a preferred embodiment, the filter conditions may be desirably related to the context of the file object attribute perspective in which they are incorporated. For example, a file object attribute perspective with a quality related context, such as exemplary Quality perspective 444 described above, may optionally comprise a filter condition such that file objects with an Author Quality object attribute value of “N/A”, or without an Author Quality attribute value are not displayed in the attribute pane. In a further example, a file object attribute perspective with a security related context may optionally comprise a filter condition such that file objects with a security access level that does not match the access level of the user selecting the security related perspective are not displayed in the attribute pane. Additional features such as a sort feature, or filter functionality as described above may also optionally be incorporated into the specification of custom user-defined file object attribute perspectives, in addition to pre-defined file object attribute perspectives.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method of displaying file object attributes of one or more file objects, comprising:
receiving, from a list of file object attribute perspectives, a selected file object attribute perspective specifying one or more file object attribute categories; and
displaying the file object attribute categories for the selected file object attribute perspective and the corresponding file object attributes for each file object.

2. The method according to claim 1, further comprising:
initially receiving a selection of at least one file object data source comprising one or more file objects.

3. The method according to claim 1, wherein each file object attribute perspective further specifies an order of file object attribute categories, and wherein the file object attribute categories of the selected file object attribute perspective are displayed in the order specified in the selected file object attribute perspective.

4. The method according to claim 1, further comprising:
initially displaying each file object, at least one default file object attribute category, and file object attributes of each file object.

5. The method according to claim 1, wherein at least one file object attribute perspective comprises a filtering condition, and wherein only file object attributes that satisfy the filtering condition are displayed.

6. The method according to claim 1, wherein at least one file object attribute perspective comprises a sort feature, and wherein the order of display of file object attributes is determined by the sort feature.

7. The method according to claim 1, wherein the one or more file objects are selected from the list comprising:
computer files, programs, directory folders, document files, text files, word processing files, spreadsheet files, database files, presentation files, graphics files, .swf files, template files, markup language files, hyperlinks, executable files, data connections, computer connections, users, servers, user groups, server groups, user profiles, calendar files, email files, network access levels, network profiles, business intelligence files, reports, templates, schedules, metrics, formulas, rules, actions, alerts, OLAP files, semantic layer objects, dashboard files, universes, universe connections, categories, dimensions, query and analysis files.

8. A method of displaying file object attributes of one or more file objects, comprising:
selecting at least one file object data source comprising one or more file objects;
activating a file object attribute perspective selection menu comprising one or more selectable file object attribute perspectives;
selecting from the file object attribute perspective selection menu a selected file object attribute perspective specifying one or more file object attribute categories; and
displaying the file object attribute categories for the selected file object attribute perspective and the corresponding file object attributes for each file object.

9. The method according to claim 8, wherein selecting further comprises defining a custom file object attribute perspective by selecting one or more file object attribute categories and storing the custom file object attribute perspective.

10. A computer readable medium storing executable instructions to graphically display file object attributes of one or more file objects, comprising executable instructions to:
receive from a list of file object attribute perspectives a selection of a selected file object attribute perspective specifying one or more file object attribute categories; and
display the file object attribute categories for the selected file object attribute perspective and the corresponding file object attributes for each file object.

11. The computer readable medium according to claim 10 further comprising executable instructions to receive a selection of at least one file object data source comprising one or more file objects.

12. The computer readable medium according to claim 10, wherein each file object attribute perspective further specifies an order of file object attribute categories, and wherein the executable instruction to display further comprises instructions to display the specified file object attribute categories in the order specified in the selected file object attribute perspective.

13. The computer readable medium according to claim 10, further comprising initial executable instructions to:
display each file object, at least one default file object attribute category and file object attributes of each file object corresponding to each default file object attribute category.

14. The computer readable medium according to claim 10, wherein at least one file object attribute perspective comprises a filtering condition and wherein only file object attributes that satisfy the filtering condition are displayed

15. The computer readable medium according to claim 10, wherein at least one file object attribute perspective comprises a sort feature and wherein the order of display of file object attributes is determined by the sort feature.
